(19) United States
(12) Patent Application Publication
(10) Pub. No.: US 2016/0341017 A1
(43) Pub. Date: Nov. 24, 2016

(54) Methods Using Viscoelastic Surfactant Based Abrasive Fluids for Perforation and Cleanout

(71) Applicant: Schlumberger Technology Corporation, Sugar Land, TX (US)

(72) Inventors: Diankui Fu, Kuala Lumpur (MY); Kong Teng Ling, Batu Anam (MY); Wassim Kharrat, Sfax (TN)

(21) Appl. No.: 14/717,588

(22) Filed: May 20, 2015

(51) Int. Cl. E21B 43/114; E21B 37/06; C09K 8/52; E21B 41/00

(52) U.S. Cl. CPC E21B 43/114; E21B 41/0078; E21B 37/06; C09K 8/52; C09K 2208/30

(57) ABSTRACT

A method includes positioning at least one fluid nozzle disposed upon a distal end of a fluid conduit in a cased borehole penetrating a subterranean formation at a target zone of the subterranean formation. An abrasive laden fluid is then continuously pumped through the fluid conduit and through the at least one fluid nozzle at a pressure adequate to form at least one slot through the cased borehole. The abrasive fluid contains an aqueous medium, an abrasive, an optional acid, and a viscoelastic surfactant. While continuously pumping the abrasive fluid through the fluid conduit, the wellbore may be cleaned by returning debris and material generated in the operation to the surface with the fluid. In some instances, a portion of the forming a slot through the cased borehole is conducted simultaneous with the cleanout of the wellbore.

### FIELD

Methods described herein relate to perforation and cleanout of cased wellbores, and in particular, using an abrasive laden viscoelastic based fluid to create perforations in cased wellbore by jetting, and wellbore cleanout with the same fluid.

### BACKGROUND

This section provides background information to facilitate a better understanding of the various aspects of the disclosure. It should be understood that the statements in this section of this document are to be read in this light, and not as admissions of prior art.

A variety of perforating and cleaning and other stimulation techniques are conducted in wellbores drilled in geological formations. The resulting perforations and/or fractures facilitate the flow of hydrocarbon based fluids from the formation and into the wellbore. For example, the production potential of an oil or gas well can be significantly increased by improving the flowing ability of hydrocarbon based fluids through the formation and into the wellbore. Abrasive jet perforating is often performed by pumping abrasive slurry under high pressure to cut slots in casing forming perforations, and cement around a wellbore, as well as further extending the cut into the formation in order to gain contact with the reservoir. Sand is the most commonly used abrasive material for such applications. The use of coiled tubing to convey the jetting tool down a wellbore has been used to reduce run time and number of runs at deviated and separated depths. Further, abrasive jet perforating does not require explosives and thus avoids the accompanying danger involved in the storage, transport, and use of explosives.

However, often, in perforating operations, debris and other material generated from the cutting of the slots in the casing, the cement around the wellbore, and extending the cut into the formation, enter the wellbore and can fill a portion of the wellbore, as well as pores in the formation. A separate operation is then required in order remove the fill to promote or restore the productivity of the oil or gas well, and to permit the passage for operational tools, as well as to remove the choking material for completion operations. The principle of the cleaning process involves the circulation of a cleanout fluid through a fluid conduit, such as coiled tubing, to the fillface where the fill is picked up by the jetting action of nozzles disposed at an end of the fluid conduit. The fill is then transported to the surface through the annulus between the fluid conduit and wellbore casing. However, while such an operation may be effective, it does require a separate entry into the wellbore from the perforation operation, and such re-entry requires additional resources, materials and time consumption which offsets a portion of the production time of the wellbore.

Further, state of the art perforating operations utilize abrasive fluids that are viscosified with polymeric viscosifiers to achieve adequate suspension properties for the abrasive carried by the fluid. Polymer based fluids often create additional wellbore and formation damage due to the tendency for the polymer to deposit on surface as leak-off dehydration occurs during the operation. Hence, post perforation treatment with cleanout fluids are generally needed for effective removal of deposited polymer.

Hence, there exists a need for improved techniques to perform cased wellbore perforation operations with fluids which overcome the difficulties of wellbore fill, polymer deposition, and separate cleanout operations, and such need is met at least in part by embodiments described in the following disclosure.

### SUMMARY

This section provides a general summary of the disclosure, and is not a necessarily a comprehensive disclosure of its full scope or all of its features.

In a first aspect of the disclosure, methods include positioning at least one fluid nozzle disposed upon a distal end of a fluid conduit in a cased borehole penetrating a subterranean formation at a target zone of the subterranean formation. An abrasive laden fluid is then continuously pumped through the fluid conduit and through the at least one fluid nozzle at a pressure adequate to form at least one slot through the cased borehole. The abrasive fluid contains an aqueous medium, an abrasive, an optional acid, and a viscoelastic surfactant. While continuously pumping the abrasive fluid through the fluid conduit, the wellbore is cleaned by suspending and returning debris and material generated in the operation to the surface with the fluid. In some instances, a portion of the forming a slot through the cased borehole is conducted simultaneous with the cleanout of the wellbore. Also, in some cases the abrasive is sand, and the viscoelastic surfactant is selected from cationic surfactants and zwitterionic surfactants. Where used, the acid may be any suitable acid, including, but not limited to, hydrochloric acid, hydrofluoric acid, formic acid or combination thereof. One example of a suitable fluid conduit is coiled tubing. The method may further include continuing the continuously pumping of the abrasive fluid through the slot through the cased borehole to form pilot holes through a wellbore filtercake, and further extending the pilot holes into the subterranean formation.

In another aspect of the disclosure, methods include positioning at least one fluid nozzle disposed upon a distal end of a coiled tubing string in a cased borehole penetrating a subterranean formation at a target zone of the subterranean formation. Then an abrasive fluid is continuously pumped through the coiled tubing string and through the at least one fluid nozzle at a pressure adequate to form at least one slot through the cased borehole and to form at least one pilot hole in the subterranean formation, where the abrasive fluid comprises an aqueous medium, an abrasive, an acid and a viscoelastic surfactant. The continuously pumping of the abrasive fluid through the fluid conduit is continued to cleanout the wellbore. In some cases, the forming pilot holes in the subterranean formation and the cleanout of the wellbore are conducted in the same operation, and at least a portion of the forming a slot through the cased borehole and at least a portion of the forming pilot holes in the subterranean formation may be conducted simultaneous with the cleanout of the wellbore. The acid may be any suitable acid, including, but not limited to, hydrochloric acid, hydrofluoric acid, formic acid or combination thereof.

Another aspect includes positioning at least one fluid nozzle disposed upon a distal end of a fluid conduit a cased borehole penetrating a subterranean formation at a target zone of the subterranean formation, continuously pumping an abrasive fluid through the fluid conduit and through the at least one fluid nozzle at a pressure adequate to form at least one slot through the cased borehole, and matrix acidizing the subterranean formation. The abrasive fluid contains at least an aqueous medium, an abrasive, an acid and a viscoelastic surfactant. Cleaning the wellbore is conducted while continuously pumping the abrasive fluid through the fluid conduit. In some cases, the fluid conduit is coiled tubing.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 illustrates a schematic side view (not necessarily to scale) of an abrasive jet tool disposed in a cased wellbore, used in accordance with an aspect of the disclosure; and,

FIG. 2 depicts a schematic side view (not necessarily to scale) of an abrasive jet tool disposed in a cased wellbore and disposed on a coiled tubing fluid conduit in fluid communication with a source of aqueous medium and abrasive, useful according to some aspects of the disclosure.

### DETAILED DESCRIPTION

The following description of the variations is merely illustrative in nature and is in no way intended to limit the scope of the disclosure, its application, or uses. The description and examples are presented herein solely for the purpose of illustrating the various embodiments of the disclosure and should not be construed as a limitation to the scope and applicability of embodiments according to the disclosure. While the compositions are described herein as comprising certain materials, it should be understood that the composition could optionally comprise two or more chemically different materials. In addition, the composition can also comprise some components other than the ones already cited. In the summary of the disclosure and this detailed description, each numerical value should be read once as modified by the term “about” (unless already expressly so modified), and then read again as not so modified unless otherwise indicated in context. Also, in the summary of the disclosure and this detailed description, it should be understood that a concentration or amount range listed or described as being useful, suitable, or the like, is intended that any and every concentration or amount within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors had possession of the entire range and all points within the range.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of concepts according to the disclosure. This description should be read to include one or at least one and the singular also includes the plural unless otherwise stated.

The terminology and phraseology used herein is for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited.

Also, as used herein any references to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment.

Embodiments according to the disclosure include using an abrasive laden viscoelastic surfactant based fluid pumped through at least one fluid nozzle disposed upon a distal end of a fluid conduit to form at least one slot through a cased borehole, and cleanout of the wellbore using the same fluid. In some cases, the forming of the slot through the cased borehole and the cleanout of the wellbore are conducted simultaneously. Further, the abrasive fluid may be further pumped through the at least one slot formed through the cased borehole to then form pilot holes through a wellbore filtercake, and further extending the pilot holes into the subterranean formation surrounding the cased borehole. Use of the viscoelastic surfactant based fluid provides improvement to the cutting effect of the abrasive as well as giving rise to cleaning by high pressure wash and producing deeper/larger slots, which help in bypassing the near wellbore filter cake and further reduce the fracture initiation pressure. In some aspects, after forming the slots with the abrasive laden viscoelastic surfactant based fluid, the slots are acid washed with the same fluid which may increase the injectivity for matrix acidizing/fracturing, which results in increased operational efficiency, since separate fluids and steps are not required.

The high-pressure perforating and cleaning may be performed using any suitable arrangement, which may include devices such as the AbrasiFRAC™ jetting device commercially available from Schlumberger Technology Corporation of Sugar Land, Tex. Such devices use a high-performance abrasive jetting tool that operate continuously under harsh downhole conditions. After depth correlation, abrasive laden fluid is pumped through the nozzles. The resulting high-velocity fluid stream perforates cased wellbores and surrounding cement when present, and then may penetrate into the formation, while the abrasive laden viscoelastic based fluid also cleans the wellbore of debris and material generated in the operation. The first zone may then be treated and the tool may be positioned in the wellbore at a next zone. Once the first treatment is complete, a sand plug may be set for isolation and a next zone perforated, cleaned and treated. This sequence can be repeated as often as necessary in a single operation. When all zones are treated, the sand plugs may be reverse-circulated out.

Embodiments according to the disclosure may be useful to help prevent wellbore fill and formation deposition from debris and material generated during the perforation. In such cases, as the debris and material is generated during perforation, the viscoelastic based abrasive laden fluid may suspend the debris and material thus preventing the deposition and/or settling of such, and even carry the material to the surface for removal from the wellbore. As such, the fluid functions to serve both as an abrasive for creating the perforation(s) and cleanout of the wellbore.

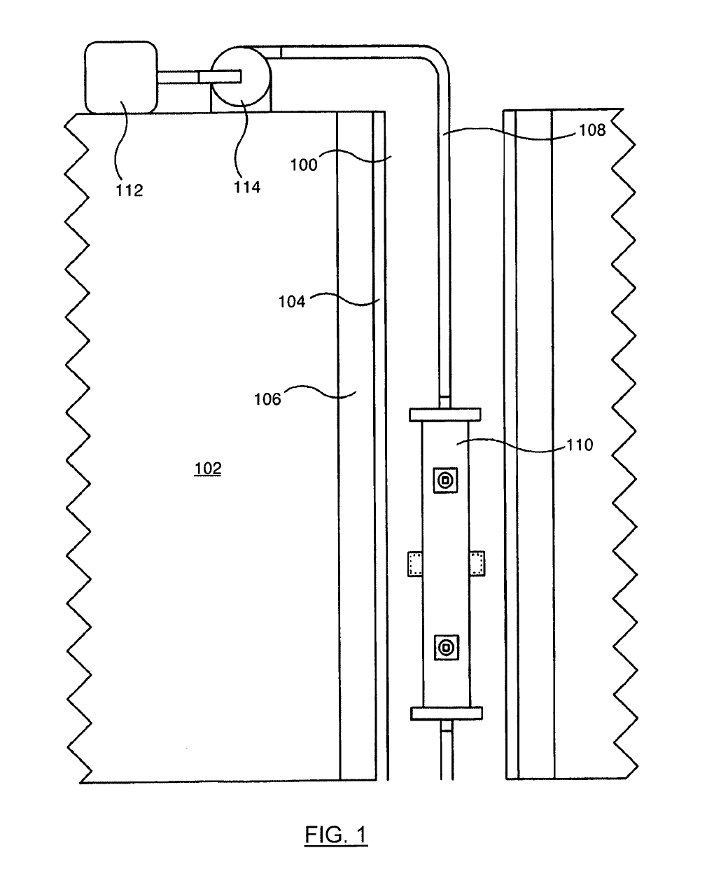

FIG. 1 generally shows a schematic side view (not necessarily to scale) of an abrasive jet tool disposed in a cased wellbore. FIG. 1 depicts a bottomhole assembly for cutting casing in a wellbore using an abrasive jet perforating tool, such as may be used in some embodiments of the disclosure. A wellbore 100 is shown penetrating subterranean formation 102. The wellbore 100 is surrounded by a casing 104 (or liner) to form a cased wellbore, which in turn may be surrounded by cement 106, sealably securing the casing 104 within the subterranean formation 102. Fluid conduit 108 extends vertically downward into the wellbore 100. The fluid conduit 108 may be jointed pipe, coiled tubing, or any other type of tubing useful in a well. Where fluid conduit 108 is coiled tubing, it is often chosen for use in horizontal or highly deviated wells, which require for substantially longer conduit runs, and higher-angle deployments than are possible on other types of fluid conduit.

Suspended from the fluid conduit 108 is an abrasive jet tool 110. Surface equipment, such as mixing tank 112 and pump 114, provide a slurry of abrasive-containing fluid to the abrasive jet tool 110 by means of the fluid conduit 108. The abrasive jet tool 110 includes at least one fluid nozzle 116, and may be, but is not limited to, an abrasive jet perforating tool, abrasive jet cutting tool, abrasive jet cleaning tool, or abrasive jet tool performing multiple functions. While abrasive jet tool 110 shown in FIG. 1 includes two fluid nozzles, it is within the scope of the disclosure to utilize any suitable number of fluid nozzles, disposed and orientated in any suitable arrangement, on an abrasive jet tool. Further, some non-limiting exemplary phasing angles between fluid nozzles may be 180°, 120°, 90°, 60°, or even 0° (for a single nozzle).

Another example of an abrasive jet tool useful in some embodiments according to the disclosure is a drop ball—activated perforating tool disposed on a distal end of a coiled tubing string. Abrasive laden fluid is pumped down the length of coiled tubing and then through an engineered bullnose jetting nozzle directly to the casing to perforate and cut into the formation. Although not limiting, in some embodiments, the jet tool is approximately 12 in length, includes three jetting ports at 120° phasing, and is controlled with about 0.5 inch diameter drop balls. This abrasive jet tool may be used with stimulation tools also disposed on the coiled tubing string. After jetting perforations and cleaning with the abrasive jet tool, the jet tool nozzles are isolated using an internal sleeve, and the jet tool moved a distance from the perforations. A stimulation treatment is then performed through the perforations with a stimulation tool, by either pumping down treatment fluid through the coiled tubing, or via the annulus space between the coiled tubing and the wellbore casing. After the stimulation treatment operation is performed with the stimulation tool, a ball is dropped from the surface to shift a piston in the abrasive jet tool which blocks the downward flow of fluids into the stimulation tool. The flow is then redirected out of the nozzles in the abrasive jet tool, which may be used to clean the wellbore, create further perforation(s) or combination of both.

As indicated above, embodiments may also include wellbore cleanout using the same tool, which occurs in the same operation as perforating and in some instances, simultaneous to the perforation formation. During cleanout, materials generated in the perforating action, as well as materials already present in the wellbore, are removed by returning to the surface to avoid restriction of post operation oil or gas fluid flow through the wellbore. It also may prevent the opening or closing of downhole control devices such as sleeves and valves. The material removal involves pumping the fluid through the jet nozzle run on the end of the fluid conduit. The fluids carry the materials back to the surface through the annulus between the fluid conduit and the interior of the cased wellbore. In some cases, the abrasive jet perforating tool can be used to remove scale from a wellbore in the cleanout operation. In such cases, the jetting action from the nozzles removes scale from the casing walls during the same perforation operation.

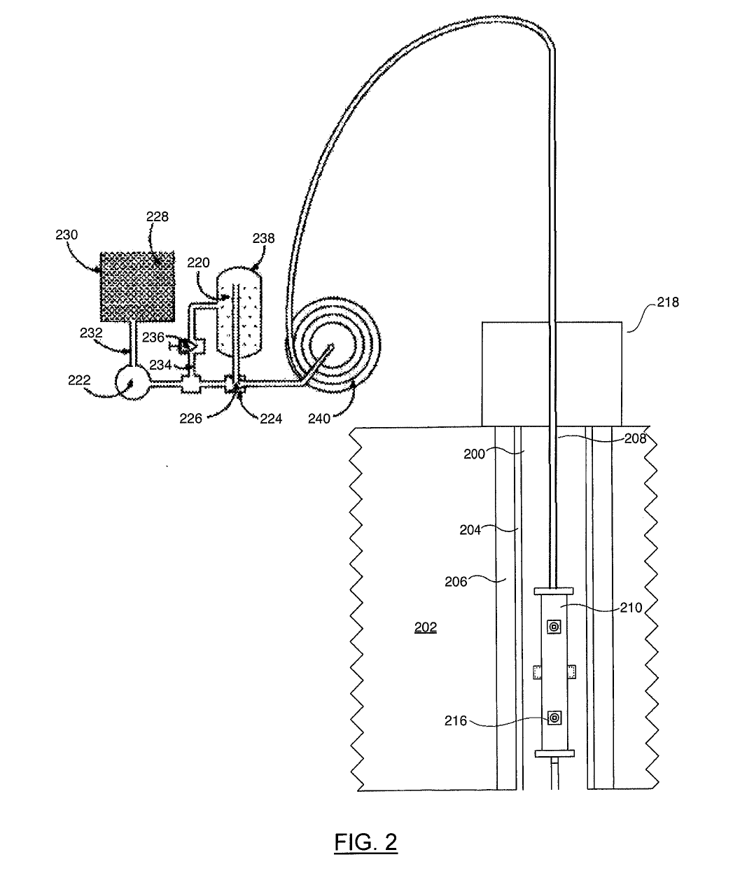

Now referring to FIG. 2, which illustrates a schematic side view (not necessarily to scale) of an abrasive jet tool disposed in a cased wellbore and disposed on a coiled tubing fluid conduit in fluid communication with a source of aqueous medium and abrasive. A wellbore 200 surrounded by a casing 204 to form a cased wellbore is shown penetrating subterranean formation 202. The wellbore 200 may be surrounded by cement 206, sealably securing the casing 204 within the subterranean formation 202. Coiled tubing 208 extends vertically downward into the wellbore 200. Attached to coiled tubing 208 is abrasive jet tool 210 which includes at least one fluid nozzle 216. Apparatus 218 serves to inject the coiled tubing into the wellbore, control and confine the pressure within the wellbore, as well as control and distribute flowback of the abrasive fluid from the wellbore. Apparatus 218 may be any arrangement of components readily know to those of skill in the art.

In FIG. 2, abrasive material 220, such as sand or silica, is mixed with the high-pressure pump 222 fluid flow at mixing valve 224. Mixing valve 224 may further include a venturi 226, to produce a jet effect, thereby creating a vacuum aid in drawing the abrasive water (slurry) mixture. FIG. 2 represents one nonlimiting example of how an abrasive fluid is formed, conveyed through coiled tubing, and used in a high pressure abrasive fluid stream to perforate and optionally clean the wellbore. Aqueous fluid 228, which contains an aqueous medium, viscoelastic surfactant and an optional acid, to be mixed and pumped is contained in tank 230 and flows to a high-pressure pump 222 through pipe 232. The high-pressure pump 222 increases pressure and part of the fluid flowing from the high-pressure pump 222 is diverted to flow pipe 234, then into fluid slurry control valve 236 and into abrasive pressure vessel 238 containing abrasive material 220. Typically about a 10% flow rate is directed via flow pipe 234 and fluid slurry control valve 236 to the abrasive pressure vessel 238. The flow rate is capable of being adjusted such that the abrasive will remain suspended in the fluid 228 utilized. Maintaining an effective abrasive to fluid ratio may be an important aspect as well as the type of abrasive, such as sand, proppant, garnet, various silica, copper slag, synthetic materials or corundum, which are employed. The volume of fluid 228 directed to the abrasive pressure vessel 238 may be such that the aqueous fluid and abrasive slurry are maintained at a sufficient velocity, such as about 1 to about 20 meters per second through the coiled tubing 208, so that the abrasive is kept in suspension through the jet-nozzle 216. A velocity too low may result in the abrasive falling out of the fluid and clumping up at some point, prior to exiting the jet nozzle 216. This ultimately results in less energy being delivered by the slurry at the target site. With the above-described arrangement, the abrasive laden aqueous fluid exiting the jet-nozzle 216 can achieve high velocities and be capable of cutting through practically any structure or material.

Using FIG. 2 as a non-limiting example, in operation, the coherent abrasive laden aqueous fluid is prepared and then pumped through coiled tubing reel 240, into coiled tubing 208 and out jet-nozzle 216 cutting the casing 204, and the cement bond 206 (and as required, the subterranean formation 202), as well as cleaning the wellbore 200. Although the drawings and examples refer to cutting or making a shape or window profile in the well bore casing, it should be understood by the reader that the disclosure is not limited to this embodiment an application alone, but is applicable and contemplated by the inventors to be utilized with regard to impediments and other suitable shapes and structures.

The abrasive material used in embodiments of the disclosure may be any suitable material for creating perforations, such as sand, garnet, proppant, various silica, copper slag, synthetic materials or corundum, and the like. Garnets are a complex family of silicate minerals with similar structures and a wide range of chemical compositions and properties. The general chemical formula for garnet is AB(SiO), where A can be calcium, magnesium, ferrous iron or manganese; and B can be aluminum, chromium, ferric iron, or titanium. More specifically the garnet group of minerals shows crystals with a habit of rhombic dodecahedrons and trapezohedrons. These are nesosilicates with the same general formula, A₃B₂(SiO₄)₃. Garnets show no cleavage and a dodecahedral parting. Fracture is conchoidal to uneven; some varieties are very tough and are valuable for abrasive purposes. Hardness is approximately 6.5-9.0 Mohs; specific gravity is approximately 2.1 for crushed garnet. Garnets tend to be inert and resist gradation and are excellent choices for an abrasive. Garnets can be industrially obtained quite easily in various grades. A person of ordinary skill in the art will appreciate that the abrasive material is an important consideration in the cutting process and the application of the proper abrasive with the superior apparatus and method of the present disclosure provides a substantial improvement over the prior art.

Incorporation of viscoelastic surfactant (VES) into fluids used in embodiments of the disclosure provides low friction during pumping, which in some cases, is highly effective for coiled tubing conveyed abrasive jetting applications. Also, certain viscoelastic surfactants exhibit excellent rheology properties for transportation of abrasive materials. The viscoelastic surfactant may be selected from the group consisting of cationic, anionic, zwitterionic, amphoteric, nonionic and combinations thereof. Some nonlimiting examples are those cited in U.S. Pat. No. 6,435,277 (Qu et al.) and U.S. Pat. No. 6,703,352 (Dahayanake et al.), each of which are incorporated herein by reference. The viscoelastic surfactants, when used alone or in combination, are capable of forming micelles that form a structure in an aqueous environment that contribute to the increased viscosity of the fluid (also referred to as “viscosifying micelles”). These fluids are normally prepared by mixing in appropriate amounts of viscoelastic surfactant suitable to achieve the desired viscosity. The viscosity of viscoelastic surfactant fluids may be attributed to the three dimensional structure formed by the components in the fluids. When the concentration of surfactants in a viscoelastic fluid significantly exceeds a critical concentration, and in most cases in the presence of an electrolyte, surfactant molecules aggregate into species such as micelles, which can interact to form a network exhibiting viscous and elastic behavior.

In general, particularly suitable zwitterionic surfactants have the formula:

RCONH—(CH₂)ₐ(CH₂CH₂O)ₘ(CH₂)_{b}—N⁺(CH₃)₂—(CH₂)_{a′}(CH₂CH₂O)_{m′}(CH₂)_{b′}COO⁻

in which R is an alkyl group that contains from about 17 to about 23 carbon atoms which may be branched or straight chained and which may be saturated or unsaturated; a, b, a′, and b′ are each from 0 to 10 and m and m′ are each from 0 to 13; a and b are each 1 or 2 if m is not 0 and (a+b) is from 2 to 10 if m is 0; a′ and b′ are each 1 or 2 when m′ is not 0 and (a′+b′) is from 1 to 5 if m is 0; (m+m′) is from 0 to 14; and CH₂CH₂O may also be OCH₂CH₂.

Zwitterionic viscoelastic surfactants include betaines. Two suitable examples of betaines are BET-O and BET-E. The surfactant in BET-O-30 is shown below; one chemical name is oleylamidopropyl betaine. It is designated BET-O-30 because as obtained from the supplier (Rhodia, Inc. Cranbury, N.J., U. S. A.) it is called Mirataine BET-O-30 because it contains an oleyl acid amide group (including a C₁₇H₃₃ alkene tail group) and contains about 30% active surfactant; the remainder is substantially water, sodium chloride, and propylene glycol. An analogous material, BET-E-40, is also available from Rhodia and contains an erucic acid amide group (including a C₂₁H₄₁ alkene tail group) and is approximately 40% active ingredient, with the remainder being substantially water, sodium chloride, and isopropanol. Viscoelastic surfactant systems, in particular BET-E-40, optionally contain about 1% of a condensation product of a naphthalene sulfonic acid, for example sodium polynaphthalene sulfonate, as a rheology modifier, as described in U. S. Patent Application Publication No. 2003-0134751. The surfactant in BET-E-40 is also shown below; one chemical name is erucylamidopropyl betaine. As-received concentrates of BET-E-40 were used in the experiments reported below, where they will be referred to as “VES” and “VES-1”. BET surfactants, and other viscoelastic surfactants that are suitable, are described in U. S. Pat. No. 6,258,859. According to that patent, BET surfactants make viscoelastic gels when in the presence of certain organic acids, organic acid salts, or inorganic salts; in that patent, the inorganic salts were present at a weight concentration up to about 30%. Co-surfactants may be useful in extending the brine tolerance, and to increase the gel strength and to reduce the shear sensitivity of the viscoelastic surfactant fluid, in particular for BET-O-type surfactants. An example given in U. S. Pat. No. 6,258,859 is sodium dodecylbenzene sulfonate (SDBS), also shown below. Other suitable co-surfactants include, for example those having the SDBS-like structure in which x=5-15; preferred co-surfactants are those in which x=7-15. Still other suitable co-surfactants for BET-O-30 are certain chelating agents such as trisodium hydroxyethylethylenediamine triacetate. The rheology enhancers may be used with viscoelastic surfactant fluid systems that contain such additives as co-surfactants, organic acids, organic acid salts, and/or inorganic salts.

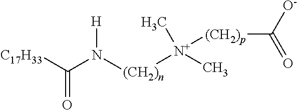

Surfactant in BET-O-30 (when n=3 and p=1)

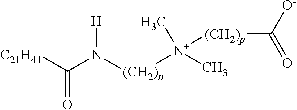

Surfactant in BET-E-40 (when n=3 and p=1)

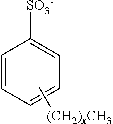

SDBS (when x=11 and the counterion is Na⁺)

Other betaines that are suitable include those in which the alkene side chain (tail group) contains 17-23 carbon atoms (not counting the carbonyl carbon atom) which may be branched or straight chained and which may be saturated or unsaturated, n=2-10, and p=1-5, and mixtures of these compounds. Betaines in which the alkene side chain contains 17-21 carbon atoms (not counting the carbonyl carbon atom) which may be branched or straight chained and which may be saturated or unsaturated, n=3-5, and p=1-3, and mixtures of these compounds, are particularly suitable. These surfactants are used at a concentration of about 0.5 to about 10%, from about 1 to about 5%, or even from about 1.5 to about 4.5%.

Exemplary cationic viscoelastic surfactants include the amine salts and quaternary amine salts disclosed in U.S. Pat. No. 5,979,557 (incorporated herein by reference) and U.S. Pat. No. 6,435,277. Examples of suitable cationic viscoelastic surfactants include cationic surfactants having the structure:

R₁N⁺(R₂)(R₃)(R₄)X⁻

in which R₁ has from about 14 to about 26 carbon atoms and may be branched or straight chained, aromatic, saturated or unsaturated, and may contain a carbonyl, an amide, a retroamide, an imide, a urea, or an amine; R₂ , R₃, and R₄ are each independently hydrogen or a C₁ to about C₆ aliphatic group which may be the same or different, branched or straight chained, saturated or unsaturated and one or more than one of which may be substituted with a group that renders the R₂, R₃, and R₄ group more hydrophilic; the R₂, R₃ and R₄ groups may be incorporated into a heterocyclic 5- or 6-member ring structure which includes the nitrogen atom; the R₂, R₃ and R₄ groups may be the same or different; R₁, R₂, R₃ and/or R₄ may contain one or more ethylene oxide and/or propylene oxide units; and X⁻ is an anion. Mixtures of such compounds are also suitable. As a further example, R₁ is from about 18 to about 22 carbon atoms and may contain a carbonyl, an amide, or an amine, and R₂, R₃, and R₄ are the same as one another and contain from 1 to about 3 carbon atoms.

Cationic surfactants having the structure R₁N⁺(R₂)(R₃)(R₄)X⁻ may optionally contain amines having the structure R₁N(R₂)(R₃). It is well known that commercially available cationic quaternary amine surfactants often contain the corresponding amines (in which R₁, R₂, and R₃ in the cationic surfactant and in the amine have the same structure). As received commercially available viscoelastic surfactant concentrate formulations, for example cationic viscoelastic surfactant formulations, may also optionally contain one or more members of the group consisting of alcohols, glycols, organic salts, chelating agents, solvents, mutual solvents, organic acids, organic acid salts, inorganic salts, oligomers, polymers, co-polymers, and mixtures of these members. They may also contain performance enhancers, such as viscosity enhancers, for example polysulfonates, for example polysulfonic acids, as described in copending U. S. Patent Application Publication No. 2003-0134751 which has a common Assignee as the present application and which is hereby incorporated by reference.

Another suitable cationic viscoelastic surfactant is erucyl bis(2-hydroxyethyl) methyl ammonium chloride, also known as (Z)-13 docosenyl-N-N-bis (2-hydroxyethyl) methyl ammonium chloride. It is commonly obtained from manufacturers as a mixture containing about 60 weight percent surfactant in a mixture of isopropanol, ethylene glycol, and water. Other suitable amine salts and quaternary amine salts include (either alone or in combination in accordance with the disclosure), erucyl trimethyl ammonium chloride; N-methyl-N,N-bis(2-hydroxyethyl) rapeseed ammonium chloride; oleyl methyl bis(hydroxyethyl) ammonium chloride; erucylamidopropyltrimethylamine chloride, octadecyl methyl bis(hydroxyethyl) ammonium bromide; octadecyl tris(hydroxyethyl) ammonium bromide; octadecyl dimethyl hydroxyethyl ammonium bromide; cetyl dimethyl hydroxyethyl ammonium bromide; cetyl methyl bis(hydroxyethyl) ammonium salicylate; cetyl methyl bis(hydroxyethyl) ammonium 3,4,-dichlorobenzoate; cetyl tris(hydroxyethyl) ammonium iodide; cosyl dimethyl hydroxyethyl ammonium bromide; cosyl methyl bis(hydroxyethyl) ammonium chloride; cosyl tris(hydroxyethyl) ammonium bromide; dicosyl dimethyl hydroxyethyl ammonium bromide; dicosyl methyl bis(hydroxyethyl) ammonium chloride; dicosyl tris(hydroxyethyl) ammonium bromide; hexadecyl ethyl bis(hydroxyethyl) ammonium chloride; hexadecyl isopropyl bis(hydroxyethyl) ammonium iodide; and cetylamino, N-octadecyl pyridinium chloride.

Many fluids made with viscoelastic surfactant systems, for example those containing cationic surfactants having structures similar to that of erucyl bis(2-hydroxyethyl) methyl ammonium chloride, inherently have short re-heal times and the rheology enhancers may not be needed except under special circumstances, for example at very low temperature.

Amphoteric viscoelastic surfactants are also suitable. Exemplary amphoteric viscoelastic surfactant systems include those described in U.S. Pat. No. 6,703,352, for example amine oxides. Other exemplary viscoelastic surfactant systems include those described in U.S. Patent Application Nos. 2002/0147114, 2005/0067165, and 2005/0137095, for example amidoamine oxides. These four references are hereby incorporated in their entirety. Mixtures of zwitterionic surfactants and amphoteric surfactants are suitable. An example is a mixture of about 13% isopropanol, about 5% 1-butanol, about 15% ethylene glycol monobutyl ether, about 4% sodium chloride, about 30% water, about 30% cocoamidopropyl betaine, and about 2% cocoamidopropylamine oxide.

The viscoelastic surfactant system may also be based upon any suitable anionic surfactant. In some embodiments, the anionic surfactant is an alkyl sarcosinate. The alkyl sarcosinate can generally have any number of carbon atoms. Presently preferred alkyl sarcosinates have about 12 to about 24 carbon atoms. The alkyl sarcosinate can have about 14 to about 18 carbon atoms. Specific examples of the number of carbon atoms include 12, 14, 16, 18, 20, 22, and 24 carbon atoms. The anionic surfactant is represented by the chemical formula:

R₁CON(R₂)CH₂X

wherein R₁ is a hydrophobic chain having about 12 to about 24 carbon atoms, R₂ is hydrogen, methyl, ethyl, propyl, or butyl, and X is carboxyl or sulfonyl. The hydrophobic chain can be an alkyl group, an alkenyl group, an alkylarylalkyl group, or an alkoxyalkyl group. Specific examples of the hydrophobic chain include a tetradecyl group, a hexadecyl group, an octadecentyl group, an octadecyl group, and a docosenoic group.

When a viscoelastic surfactant is incorporated into fluids used in embodiments of the disclosure, the viscoelastic surfactant can range from about 0.2% to about 15% by weight of total weight of fluid, preferably from about 0.5% to about 15% by weight of total weight of fluid, more preferably from about 2% to about 10% by weight of total weight of fluid. The lower limit of viscoelastic surfactant should no less than about 0.2, 0.5, 0.7, 0.9, 1, 2, 3, 4, 5, 6, 7, 8, 9, 10, or 14 percent of total weight of fluid, and the upper limited being no more than about 15 percent of total fluid weight, specifically no greater than about 15, 14, 13, 12, 11, 10, 9, 8, 7, 6, 5, 1, 0.9, 0.7, 0.5 or 0.3 percent of total weight of fluid. Fluids incorporating viscoelastic surfactant based viscosifiers may have any suitable viscosity, preferably a viscosity value of less than about 100 mPa-s at a shear rate of about 100 s⁻¹ at treatment temperature, more preferably less than about 75 mPa-s at a shear rate of about 100 s⁻¹, and even more preferably less than about 50 mPa-s.

In some embodiments, an acid constituent is mixed with the aqueous medium and abrasive to form an abrasive laden acidic aqueous fluid. Use of viscoelastic surfactant acidic fluids laden with abrasive for slot cutting may further add to the cutting effect of the abrasive, which provides the benefit of acid wash and deeper/larger slots, and will help in bypassing the near wellbore filter cake as well as further reduce the fracture initiation pressure. Further, in many cases, after cutting the slots with the gelled viscoelastic surfactant acidic fluids laden with abrasive, the slots are acid washed with the same fluid for higher efficiency, since two separate fluids are not required.

The acid constituent may be one or more water soluble inorganic acids, mineral acids, or water soluble organic acids, with virtually all such known materials contemplated as being useful in the compositions used in accordance with the disclosure. Exemplary inorganic acids for use in accordance with the disclosure include phosphoric acid, potassium dihydrogenphosphate, sodium dihydrogenphosphate, sodium sulfite, potassium sulfite, sodium pyrosulfite (sodium metabisulfite), potassium pyrosulfite (potassium metabisulfite), acid sodium hexametaphosphate, acid potassium hexametaphosphate, acid sodium pyrophosphate, acid potassium pyrophosphate and sulfamic acid. Alkyl sulfonic acids, e.g., methane sulfonic acid may also be used as a component of the acid system. Strong inorganic acids such as hydrofluoric acid, hydrochloric acid, nitric acid and sulfuric acid may also be used, however are less preferred due to their strong acid character; if present are present in only minor amounts in the acid system. The use of water soluble acids are preferred, including water soluble salts of organic acids. Exemplary organic acids are those which generally include at least one carbon atom, and include at least one carboxyl group (—COOH) in its structure. Exemplary useful water soluble organic acids which contain from 1 to about 6 carbon atoms, and at least one carboxyl group as noted. Exemplary useful organic acids include: Exemplary organic acids which may be used include linear aliphatic acids such as acetic acid, citric acid, propionic acid, formic acid, butyric acid and valeric acid; dicarboxylic acids such as oxalic acid, malonic acid, succinic acid, glutaric acid, adipic acid, pimelic acid, fumaric acid and maleic acid; acidic amino acids such as glutamic acid and aspartic acid; and hydroxy acids such as glycolic acid, lactic acid, hydroxyacrylic acid, .alpha.-hydroxybutyric acid, glyceric acid, tartronic acid, malic acid, tartaric acid and citric acid, as well as acid salts of these organic acids.

The acid may be present in any effective amount, but typically not present in amounts of more than about 20% wt. based on the total weight of the compositions used in some embodiments. It is to be understood that the nature of the acid or acids selected to form the acid constituent will influence the amount of acid required to obtain a desired final pH or pH range, and the precise amount of acid required for a specific composition can be readily obtained by a skilled artisan utilizing conventional techniques. Further, the amount of acid present in the composition, keeping in mind any optional ingredients that may be present, should be in an amount such that the pH of the composition is about 5 or less, and especially within the preferred pH ranges indicated previously. Generally however, the acid constituent is added in an amount of from about 0.1 to 20% by weight, and in some instances, from about 3 to 15% by weight, or even from 5 to 10% by weight.

Fluids used in embodiments of the disclosure may further contain one or more conventional additives known to the well service industry such as, but not limited to, a breaker, other surfactants, surface, tension reducing agent, foaming agent, defoaming agent, demulsifier, non-emulsifier, scale inhibitor, gas hydrate inhibitor, corrosion inhibitor aid, leak-off control agent, clay stabilizer, temperature stabilizer, pH buffer, gravels, proppants, viscosifying polymer, solvent or any suitable mixture thereof. This list of additives is not exhaustive and additional additives known to those skilled in the art that are not specifically cited fall within the scope of the disclosure.

In operation, the aqueous medium used to form the fluids may be may be supplied from any practical source available given the particular treatment operation and location. Any suitable outdoor environmental water source, such as lake water, sea water, aquifer, produced water, and the like, may be used. Fresh water, supplied from a source other than the environmental source, may also be used, and in some cases, mixed with water from the environmental water source. Often, ‘produced water’ is a term used in the petroleum industry to describe water that is produced as a byproduct along with the oil and gas production or subterranean formation treatment.

In addition to the embodiments described above, the methods and fluids according to the disclosure may also be used for matrix acidizing the subterranean formation surrounding the wellbore. Matrix acidizing refers to one of two stimulation processes in which acidic fluid is injected into the well penetrating the rock pores at pressures below fracture initiation pressure. Acidizing is used to either stimulate a well to improve flow or to remove damage. During matrix acidizing the acids dissolve the sediments and mud solids within the pores that are inhibiting the permeability of the rock. This process enlarges the natural pores of the reservoir which stimulates the flow of hydrocarbons. Effective acidizing is guided by practical limits in volumes and types of acid and procedures so as to achieve an optimum removal of the formation damage around the wellbore, as will be readily known to those of skill in the art. In some aspects, methods include positioning at least one fluid nozzle disposed upon a distal end of a fluid conduit in a cased borehole at a target zone of the subterranean formation then continuously pumping the abrasive fluid down the fluid conduit, through the at least one fluid nozzle at a pressure adequate to form at least one slot through the cased borehole, and continuing the pumping to performed matrix acidizing of the subterranean formation. Simultaneously, the wellbore is cleaned with the abrasive fluid by carrying debris and material generated in the process to the surface. Generally, the abrasive fluid contains at least an aqueous medium, an abrasive, an acid and a viscoelastic surfactant. Additionally, after forming the at least one slot through the cased borehole and before performing the matrix acidizing, the jetted abrasive fluid may cut through a cement bond placed between the cased wellbore and subterranean formation, the cut through a filter cake, if present, in the subterranean formation adjacent the cement bond.

### EXAMPLES

Aqueous viscoelastic surfactant containing fluids were formulated using fresh water and the zwitterionic viscoelastic surfactant BET-E-40, available from Rhodia, Inc., which was approximately 40% as active viscoelastic surfactant, with the remainder being substantially water, sodium chloride, and isopropanol. The BET-E-40 was added in the amounts indicated in Table 1, given in amounts added by weight % of the total of the total fluid weight. The viscosity was measured on the samples disclosed below with a Fann 35 rheometer, and the dial centipoise (cP) viscosity value was acquired at various RPM values. Hydrochloric acid was added to the mixtures in amount of about 10% by weight. Sand was added to each of the samples in an amount of 1 ppa (one pound of sand per gallon of fluid). Sand settling was measured by pouring the fluid into a 100 ml graduated cylinder and degree of settling was observed and measured in ml at the times indicated, as shown in Table 2.

TABLE 1

| Fann 35 | Sample 1 | Sample 2 | Sample 3 |
|---|---|---|---|
| Speed (rpm) | 3% BET-E-40 | 5% BET-E-40 | 7% BET-E-40 |
| 600 | 35 | 69 | 110 |
| 300 | 26 | 55 | 83 |
| 200 | 23 | 49 | 76 |
| 100 | 17 | 37 | 64 |
| 6 | 9 | 18 | 34 |
| 3 | 6 | 15 | 30 |

TABLE 2
Sand Settling result (1ppa of 20/40 sand)

| | Sample 1 | Sample 2 | Sample 3 |
|---|---|---|---|
| Minutes | 3% BET-E-40 | 5% BET-E-40 | 7% BET-E-40 |
| 0 | 0 | 0 | 0 |
| 10 | 3.1 | 0 | 0 |
| 20 | 4.6 | 0 | 0 |
| 30 | 6.2 | 0 | 0 |
| 40 | 6.2 | 0 | 0 |
| 50 | 6.2 | 0.83 | 0 |
| 60 | 6.2 | 1.67 | 0 |

The data presented in Tables 1 and 2 show how the viscoelastic surfactant viscosifies the fluid to provide adequate low viscosity for pumping while still remaining high enough for suspending abrasive particles. This is particularly the case at levels of 5% by weight viscoelastic surfactant and above, however, in some instances levels of viscoelastic surfactant below 5% provide fluids with practical viscosity and abrasive particle suspension properties.

The foregoing description of the embodiments has been provided for purposes of illustration and description. Example embodiments are provided so that this disclosure will be sufficiently thorough, and will convey the scope to those who are skilled in the art. Numerous specific details are set forth such as examples of specific components, devices, and methods, to provide a thorough understanding of embodiments of the disclosure, but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Also, in some example embodiments, well-known processes, well-known device structures, and well-known technologies are not described in detail. Further, it will be readily apparent to those of skill in the art that in the design, manufacture, and operation of apparatus to achieve that described in the disclosure, variations in apparatus design, construction, condition, erosion of components, gaps between components may present, for example.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A method comprising:
positioning at least one fluid nozzle disposed upon a distal end of a fluid conduit in a cased borehole penetrating a subterranean formation at a target zone of the subterranean formation;
continuously pumping an abrasive fluid through the fluid conduit and through the at least one fluid nozzle at a pressure adequate to form at least one slot through the cased borehole, wherein the abrasive fluid comprises an aqueous medium, an abrasive, and a viscoelastic surfactant; and,
continuing the continuously pumping of the abrasive fluid through the fluid conduit to cleanout the wellbore.

2. The method of claim 1 wherein the forming a slot through the cased borehole and the cleanout of the wellbore are conducted in the same operation.

3. The method of claim 1 wherein a portion of the forming a slot through the cased borehole is conducted simultaneous with the cleanout of the wellbore.

4. The method of claim 1 wherein the fluid conduit comprises coiled tubing.

5. The method of claim 1 wherein the abrasive comprises sand.

6. The method of claim 1 further comprising continuing the continuously pumping of the abrasive fluid through the slot through the cased borehole to form pilot holes through a wellbore filtercake, and further extending the pilot holes into the subterranean formation.

7. The method of claim 1 wherein the fluid further comprises an acid.

8. The method of claim 7 wherein the acid comprises hydrochloric acid, hydrofluoric acid, formic acid or combination thereof.

9. The method of claim 7 wherein the slots formed through the cased borehole are acid washed to increase the injectivity for a matrix acidizing or fracturing treatment.

10. The method of claim 1 wherein the viscoelastic surfactant is selected from cationic surfactants and zwitterionic surfactants.

11. The method of claim 10 wherein the viscoelastic surfactant comprises a zwitterionic betaine surfactant.

12. The method of claim 1 wherein the viscoelastic surfactant is incorporated into the abrasive fluid in an amount from about 1% to 15% by weight of total fluid weight.

13. A method comprising:
positioning at least one fluid nozzle disposed upon a distal end of a coiled tubing string in a cased borehole penetrating a subterranean formation at a target zone of the subterranean formation;
continuously pumping an abrasive fluid through the coiled tubing string and through the at least one fluid nozzle at a pressure adequate to form at least one slot through the cased borehole and to form at least one pilot hole in the subterranean formation, wherein the abrasive fluid comprises an aqueous medium, an abrasive, an acid and a viscoelastic surfactant; and,
continuing the continuously pumping of the abrasive fluid through the fluid conduit to cleanout the wellbore.

14. The method of claim 13 wherein the forming a slot through the cased borehole, the forming pilot holes in the subterranean formation and the cleanout of the wellbore are conducted in the same operation.

15. The method of claim 13 wherein at least a portion of the forming a slot through the cased borehole and at least a portion of the forming pilot holes in the subterranean formation are conducted simultaneous with the cleanout of the wellbore.

16. The method of claim 13 wherein the acid is hydrochloric acid, hydrofluoric acid, formic acid or combination thereof.

17. A method comprising:
positioning at least one fluid nozzle disposed upon a distal end of a fluid conduit in a cased borehole penetrating a subterranean formation at a target zone of the subterranean formation;
continuously pumping an abrasive fluid through the fluid conduit and through the at least one fluid nozzle at a pressure adequate to form at least one slot through the cased borehole and matrix acidizing the subterranean formation, wherein the abrasive fluid comprises an aqueous medium, an abrasive, an acid and a viscoelastic surfactant; and,
cleaning the wellbore while continuously pumping the abrasive fluid through the fluid conduit.

18. The method of claim 17 wherein the acid comprises hydrochloric acid, hydrofluoric acid, formic acid or combination thereof.

19. The method of claim 17 wherein the at least one fluid nozzle comprises three fluid nozzles.

20. The method of claim 17 wherein the fluid conduit comprises coiled tubing.
